(19) United States
(12) Patent Application Publication
(10) Pub. No.: US 2026/0030578 A1
(43) Pub. Date: Jan. 29, 2026

(54) PRODUCTIVITY OPTIMIZATION SYSTEM AND METHOD FOR EARLY LIFECYCLE COMPUTING DEVICES

(71) Applicant: Dell Products L.P., Round Rock, TX (US)

(72) Inventors: Kearson M. McNulty, Austin, TX (US); Marcus Daniel Molner, Austin, TX (US); Jimmy L. Griffith, Pflugerville, TX (US); Trent A. Buys, Seattle, WA (US); David Allen Dyson, Pflugerville, TX (US); Suraj M Varma, Portland, OR (US); Walter Kemp, Georgetown, TX (US)

(73) Assignee: Dell Products L.P., Round Rock, TX (US)

(21) Appl. No.: 18/786,768

(22) Filed: Jul. 29, 2024

(51) Int. Cl. G06Q 10/0633

(52) U.S. Cl. CPC G06Q 10/0633

(57) ABSTRACT

Embodiments of the present disclosure provide an Information Handling System (IHS) productivity optimization system that may be used to optimize an IHS during its early lifecycle. According to one embodiment, an Information Handling System (IHS) includes executable instructions to create a temporary workspace for the end user, and as the IHS is being configured for use by the end user, provide the workspace for use by the user on the IHS. When the configuration of the IHS is completed, the instructions begin providing the IHS for use by the user.

### BACKGROUND

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

IHSs provide users with capabilities for accessing, creating, and manipulating data. Many organizations have determined that it is no longer necessary to operate and maintain multiple IHSs (e.g., servers, network switches, storage arrays, etc.) due to readily available virtualized Information Technology (IT) infrastructures. These virtualized infrastructures typically involve a virtualized environment where data is processed within an isolated software environment that operates on the IHS, where such isolated software environments may be referred to by various names, such as virtual machines (VMs), containers, dockers, and the like. Moreover, it has been determined that it can be more cost-efficient to outsource operations to a hosting service provider that provides enhanced economies of scale by consolidating the IT operations of many organizations into a single data center.

Sharing infrastructure resources often saves on equipment costs. For example, a hosting service provider may run and maintain applications that may be available via a software-as-a-service (SAAS) platform, or certain resources that may be available via an infrastructure-as-a-service (IAAS) platform. In such cases, the hosting service provider charges its customers based on usage of the applications or containers (e.g., VMs, dockers, etc.) using a multi-tenant architecture, which allows applications and/or containers from different organizations to simultaneously use the same hardware. The multi-tenant architecture often results in less equipment required, while requiring fewer IT personnel to maintain acceptable quality of service goals.

### SUMMARY

Embodiments of the present disclosure provide an Information Handling System (IHS) productivity optimization system that may be used to optimize an IHS during its early lifecycle. According to one embodiment, an Information Handling System (IHS) includes executable instructions to create a temporary workspace for the end user, and as the IHS is being configured for use by the end user, provide the workspace for use by the user on the IHS. When the configuration of the IHS is completed, the instructions begin providing the IHS for use by the user.

According to another embodiment, an IHS productivity optimization method includes the steps of, when an IHS is initially provided to an end user, creating a temporary workspace for the end user, and as the IHS is being configured for use by the end user, providing the workspace for use by the user on the IHS. When the configuration of the IHS is completed, begin providing the IHS for use by the user.

According to yet another embodiment, an IHS productivity optimization system includes a cloud-based workspace infrastructure configured to create a plurality of workspaces, and executable instructions to, when the IHS is initially provided to an end user, create a temporary workspace for the end user, as the IHS is being configured for use by the end user, provide the workspace for use by the user on the HIS, and when the configuration of the IHS is completed, begin providing the IHS for use by the user.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 illustrates an example IHS productivity optimization system that may be used to optimize an IHS during its early lifecycle according to one embodiment of the present disclosure.

FIG. 2 is a block diagram illustrating components of an example IHS that may be configured to provide the IHS productivity optimization system according to one embodiment of the present disclosure.

FIG. 3 illustrates an example IHS productivity optimization method that may be used to optimize an IHS during its early lifecycle according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Currently implemented IHSs used by consumers are configured with workspaces, such as software-based workspaces (e.g., docker), hardware-based workspaces (e.g., virtualBox, VMWare, etc.), and cloud-based workspaces. To meet this demand, many computing devices (e.g., IHSs) are now being provided with workspace orchestrators that manage how the workspaces are used in the IHS. Such workspace orchestrators involve the concepts of orchestration, optimization of the IHS, and composition for OS and SOC agnostic UI/UX for modern clients, while preserving key parts of the traditional client experience (e.g., do-no-harm). The workspace orchestrator provides workload orchestration with concurrent workspaces of varying performance and security levels running on the IHS as well as in the cloud. The workspaces are implemented using container technologies.

For these workspace orchestrators, most or all applications, with the exception of certain low level OS or vendor services, are run inside of a workspace for better security and scalability reasons. The workspaces can be implemented using software isolation techniques, such as Docker, Snap, and the like or using hardware isolation methods like Hyper-V docker, lightweight VMs (e.g., Photon-OS, IncludeOS, etc.) and full bare-metal-based VMs. A workspace generally refers to an isolated environment that can host one or more applications. A workspace host refers to software based (e.g., Docker) or hypervisor/hardware based (e.g., Kata container, VM, etc.) solutions to provide the isolated environments for the workspace orchestrator.

Organizations may own and/or manage large numbers of IHSs. For instance, an employer may provide laptop computers to employees and may also operate various other types of IHSs, such as rack-mounted servers and networking equipment, in order to support operation of the laptops. The provided laptops may be operated in a variety of scenarios, both for performing job functions and for personal use. In another example, educational institutions may support various types of IHSs, such as tablets and laptops, that are issued to students and employees. Medical institutions may also support a variety of IHSs that may be used by patients, visitors and/or staff. In all such instances, the users and IHSs that are being supported is continually in flux.

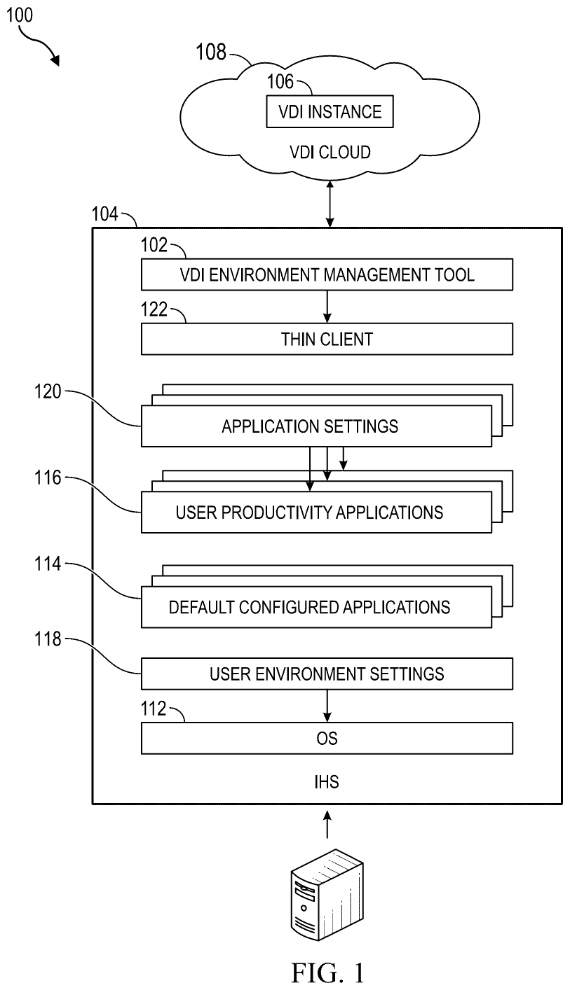

FIG. 1 illustrates an example IHS productivity optimization system 100 that may be used to optimize an IHS 104 during its early lifecycle according to one embodiment of the present disclosure. The IHS productivity optimization system 100 includes an IHS 104 configured with a VDI environment management tool 102 that, when the IHS 104 is used early in its lifecycle (e.g., recently delivered to an end user), causes a VDI instance 106 to be created in a VDI cloud 108 that can be used by the end user while the relatively new IHS 104 is being configured for use by the end user.

Embodiments of the present disclosure may be particularly well suited for use with managed IHSs that may be managed by an Information Technology Decision Maker (ITDM) or other type of administrator that oversees the operation of multiple IHSs. Organizations may own and/or manage large numbers of IHSs. For instance, an employer may provide laptop computers to employees and may also operate various other types of IHSs, such as rack-mounted servers and networking equipment, in order to support operation of the laptops. The provided laptops may be operated in a variety of scenarios, both for performing job functions and for personal use. In another example, educational institutions may support various types of IHSs, such as tablets and laptops, that are issued to students and employees. Medical institutions may also support a variety of IHSs that may be used by patients, visitors and/or staff. In all such instances, the users and IHSs that are being supported are often continually in flux.

For example, when a new employee of a corporation is initially provided with a new IHS, it may suffer performance issues while it is being configured for use by the new employee. Additionally, an employee who decides to re-image their IHS for various reasons (e.g., corruption, security, performance related issues, etc.) may encounter performance issues as the IHS is being configured for use.

When the IHS 104 is initially provided to the end user (e.g., new employee), it is usually configured with only a few features, such as an OS 112 and one or more default configured applications 114. After the IHS 104 has been provided to the end user, it is often configured with one or more additional user productivity applications 116. Moreover, as the IHS 104 is used over time, certain user environment settings 118 may be made to the IHS 104, such as the OS 112, and other certain application settings 120 made to the user productivity applications 116. These configuration changes take time to complete and place a load on a new IHS 104, thus causing its performance to suffer. As will be described in detail herein below, embodiments of the present disclosure provide a VDI environment management tool 102 that provides a VDI instance 106 via a thin client 122 running on the IHS 104 so that the loading caused by the configuration changes do not unduly reduce or hamper performance as the IHS 104 is being used. In one embodiment, the thin client 122 may include a WebView client that provides a user interface for the end user. While the present embodiment describes the use of a cloud-based VDI instance 106 (e.g., Azure Containers, AWS ECS, etc.), it should be appreciated that any suitable type of workspace may be used that is executed external to the IHS 104. Examples of such workspaces may include, for example, software-based workspaces (e.g., docker), or hardware-based workspaces (e.g., virtualBox, VMWare, etc.).

The thin client 122 generally provides a window that may be used as a user interface for the VDI instance 106 running in the VDI cloud 108. Because the VDI instance 106 is running in the VDI cloud 108, loading caused by ongoing configuration of the IHS 104 may not unduly impact how the VDI instance 106 is running. Additionally, since the thin client 122 uses limited computing resources, it may not unduly affect the configuration changes being made to the IHS 104. When the configuration changes to the IHS 104 have been completed, the VDI environment management tool 102 may have logic to migrate any recently made changes from the VDI instance 106 to the IHS 104, delete the VDI instance 106, and have the end user begin use of the IHS 104 with its recently installed configuration changes.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory.

Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below.

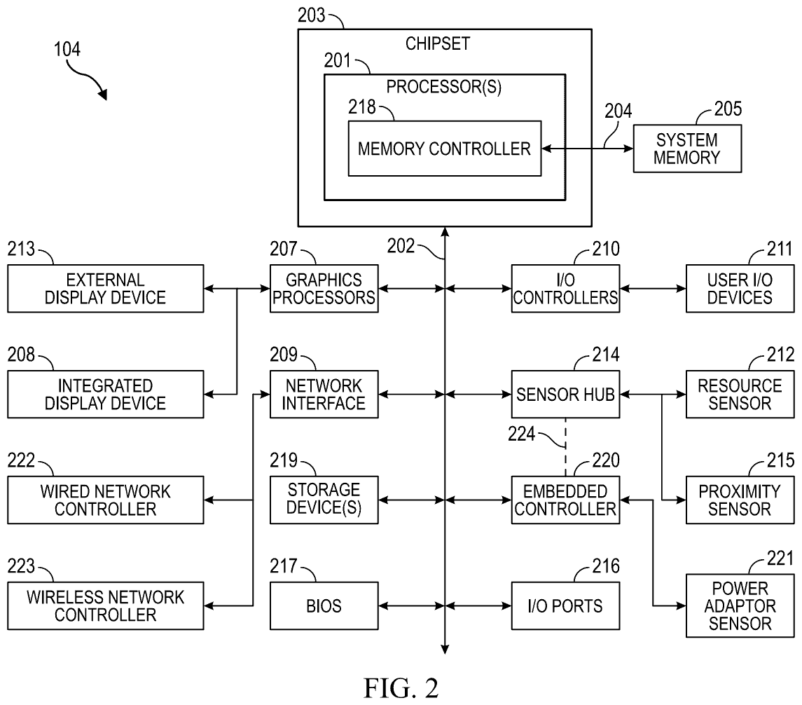

FIG. 2 is a block diagram illustrating components of an example IHS 104 that may be configured to provide the IHS productivity optimization system 100 according to one embodiment of the present disclosure. For example, IHS 104 may be incorporated in whole, or part, as the IHS 104 of FIG. 1. As shown, IHS 104 includes one or more processors 201, such as a Central Processing Unit (CPU), that execute code retrieved from system memory 205. Although IHS 104 is illustrated with a single processor 201, other embodiments may include two or more processors, that may each be configured identically, or to provide specialized processing operations. Processor 201 may include any processor capable of executing program instructions, such as an Intel Pentium™ series processor or any general-purpose or embedded processors implementing any of a variety of Instruction Set Architectures (ISAs), such as the x86, POWERPC©, ARM®, SPARC®, or MIPS® ISAs, or any other suitable ISA.

In the embodiment of FIG. 2, processor 201 includes an integrated memory controller 218 that may be implemented directly within the circuitry of processor 201, or memory controller 218 may be a separate integrated circuit that is located on the same die as processor 201. Memory controller 218 may be configured to manage the transfer of data to and from the system memory 205 of IHS 104 via high-speed memory interface 204. System memory 205 that is coupled to processor 201 provides processor 201 with a high-speed memory that may be used in the execution of computer program instructions by processor 201.

Accordingly, system memory 205 may include memory components, such as static RAM (SRAM), dynamic RAM (DRAM), NAND Flash memory, suitable for supporting high-speed memory operations by the processor 201. In certain embodiments, system memory 205 may combine both persistent, non-volatile memory and volatile memory. In certain embodiments, system memory 205 may include multiple removable memory modules.

IHS 104 utilizes chipset 203 that may include one or more integrated circuits that are connected to processor 201. In the embodiment of FIG. 2, processor 201 is depicted as a component of chipset 203. In other embodiments, all of chipset 203, or portions of chipset 203 may be implemented directly within the integrated circuitry of the processor 201. Chipset 203 provides processor(s) 201 with access to a variety of resources accessible via bus 202. In IHS 104, bus 202 is illustrated as a single element. Various embodiments may utilize any number of separate buses to provide the illustrated pathways served by bus 202.

In various embodiments, IHS 104 may include one or more I/O ports 216 that may support removable couplings with diverse types of external devices and systems, including removable couplings with peripheral devices that may be configured for operation by a particular user of IHS 104. For instance, I/O 216 ports may include USB (Universal Serial Bus) ports, by which a variety of external devices may be coupled to IHS 104. In addition to or instead of USB ports, I/O ports 216 may include diverse types of physical I/O ports that are accessible to a user via the enclosure of the IHS 104.

In certain embodiments, chipset 203 may additionally utilize one or more I/O controllers 210 that may each support the operation of hardware components such as user I/O devices 211 that may include peripheral components that are physically coupled to I/O port 216 and/or peripheral components that are wirelessly coupled to IHS 104 via network interface 209. In various implementations, I/O controller 210 may support the operation of one or more user I/O devices 211 such as a keyboard, mouse, touchpad, touchscreen, microphone, speakers, camera and other input and output devices that may be coupled to IHS 104. User I/O devices 211 may interface with an I/O controller 210 through wired or wireless couplings supported by IHS 104. In some cases, I/O controllers 210 may support configurable operation of supported peripheral devices, such as user I/O devices 211.

As illustrated, a variety of additional resources may be coupled to the processor(s) 201 of the IHS 104 through the chipset 203. For instance, chipset 203 may be coupled to network interface 209 that may support diverse types of network connectivity. IHS 104 may also include one or more Network Interface Controllers (NICs) 222 and 223, each of which may implement the hardware required for communicating via a specific networking technology, such as Wi-Fi, BLUETOOTH, Ethernet and mobile cellular networks (e.g., CDMA, TDMA, LTE). Network interface 209 may support network connections by wired network controllers 222 and wireless network controllers 223. Each network controller 222 and 223 may be coupled via various buses to chipset 203 to support diverse types of network connectivity, such as the network connectivity utilized by IHS 104.

Chipset 203 may also provide access to one or more display device(s) 208 and 213 via graphics processor 207. Graphics processor 207 may be included within a video card, graphics card or within an embedded controller installed within IHS 104. Additionally, or alternatively, graphics processor 207 may be integrated within processor 201, such as a component of a system-on-chip (SoC). Graphics processor 207 may generate Display information and provide the generated information to one or more Display device(s) 208 and 213, coupled to IHS 104.

One or more Display devices 208 and 213 coupled to IHS 104 may utilize LCD, LED, OLED, or other Display technologies. Each Display device 208 and 213 may be capable of receiving touch inputs such as via a touch controller that may be an embedded component of the Display device 208 and 213 or graphics processor 207, or it may be a separate component of IHS 104 accessed via bus 202. In some cases, power to graphics processor 207, integrated Display device 208 and/or external Display device 213 may be turned off, or configured to operate at minimal power levels, in response to IHS 104 entering a low-power state (e.g., standby).

As illustrated, IHS 104 may support an integrated Display device 208, such as a Display integrated into a laptop, tablet, 2-in-1 convertible device, or mobile device. IHS 104 may also support use of one or more external Display devices 213, such as external monitors that may be coupled to IHS 104 via distinct types of couplings, such as by connecting a cable from the external Display devices 213 to external I/O port 216 of the IHS 104. In certain scenarios, the operation of integrated displays 208 and external displays 213 may be configured for a particular user. For instance, a particular user may prefer specific brightness settings that may vary the Display brightness based on time of day and ambient lighting conditions.

Chipset 203 also provides processor 201 with access to one or more storage devices 219. In various embodiments, storage device 219 may be integral to IHS 104 or may be external to IHS 104. In certain embodiments, storage device 219 may be accessed via a storage controller that may be an integrated component of the storage device. Storage device 219 may be implemented using any memory technology allowing IHS 104 to store and retrieve data. For instance, storage device 219 may be a magnetic hard disk storage drive or a solid-state storage drive. In certain embodiments, storage device 219 may be a system of storage devices, such as a cloud system or enterprise data management system that is accessible via network interface 209.

As illustrated, IHS 104 also includes Basic Input/Output System (BIOS) 217 that may be stored in a non-volatile memory accessible by chipset 203 via bus 202. Upon powering or restarting IHS 104, processor(s) 201 may utilize BIOS 217 instructions to initialize and test hardware components coupled to the IHS 104. BIOS 217 instructions may also load an operating system (OS) (e.g., WINDOWS, MACOS, iOS, ANDROID, LINUX, etc.) for use by IHS 104.

BIOS 217 provides an abstraction layer that allows the operating system to interface with the hardware components of the IHS 104. The Unified Extensible Firmware Interface (UEFI) was designed as a successor to BIOS. As a result, many modern IHSs utilize UEFI in addition to or instead of a BIOS. As used herein, BIOS is intended to also encompass UEFI.

As illustrated, certain IHS 104 embodiments may utilize sensor hub 214 capable of sampling and/or collecting data from a variety of sensors. For instance, sensor hub 214 may utilize hardware resource sensor(s) 212, which may include electrical current or voltage sensors, and that are capable of determining the power consumption of various components of IHS 104 (e.g., CPU 201, GPU 207, system memory 205, etc.). In certain embodiments, sensor hub 214 may also include capabilities for determining a location and movement of IHS 104 based on triangulation of network signal information and/or based on information accessible via the OS or a location subsystem, such as a GPS module.

In some embodiments, sensor hub 214 may support proximity sensor(s) 215, including optical, infrared, and/or sonar sensors, which may be configured to provide an indication of a user's presence near IHS 104, absence from IHS 104, and/or distance from IHS 104 (e.g., near-field, mid-field, or far-field).

In certain embodiments, sensor hub 214 may be an independent microcontroller or other logic unit that is coupled to the motherboard of IHS 104. Sensor hub 214 may be a component of an integrated system-on-chip incorporated into processor 201, and it may communicate with chipset 203 via a bus connection such as an Inter-Integrated Circuit (I²C) bus or other suitable type of bus connection. Sensor hub 214 may also utilize an I²C bus for communicating with various sensors supported by IHS 104.

As illustrated, IHS 104 may utilize embedded controller (EC) 220, which may be a motherboard component of IHS 104 and may include one or more logic units. In certain embodiments, EC 220 may operate from a separate power plane from the main processors 201 and thus the OS operations of IHS 104. Firmware instructions utilized by EC 220 may be used to operate a secure execution system that may include operations for providing various core functions of IHS 104, such as power management, management of operating modes in which IHS 104 may be physically configured and support for certain integrated I/O functions.

EC 220 may also implement operations for interfacing with power adapter sensor 221 in managing power for IHS 104. These operations may be utilized to determine the power status of IHS 104, such as whether IHS 104 is operating from battery power or is plugged into an AC power source (e.g., whether the IHS is operating in AC-only mode, DC-only mode, or AC+DC mode). In some embodiments, EC 220 and sensor hub 214 may communicate via an out-of-band signaling pathway or bus 224.

In various embodiments, IHS 104 may not include each of the components shown in FIG. 2. Additionally, or alternatively, IHS 104 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 201 as an SoC.

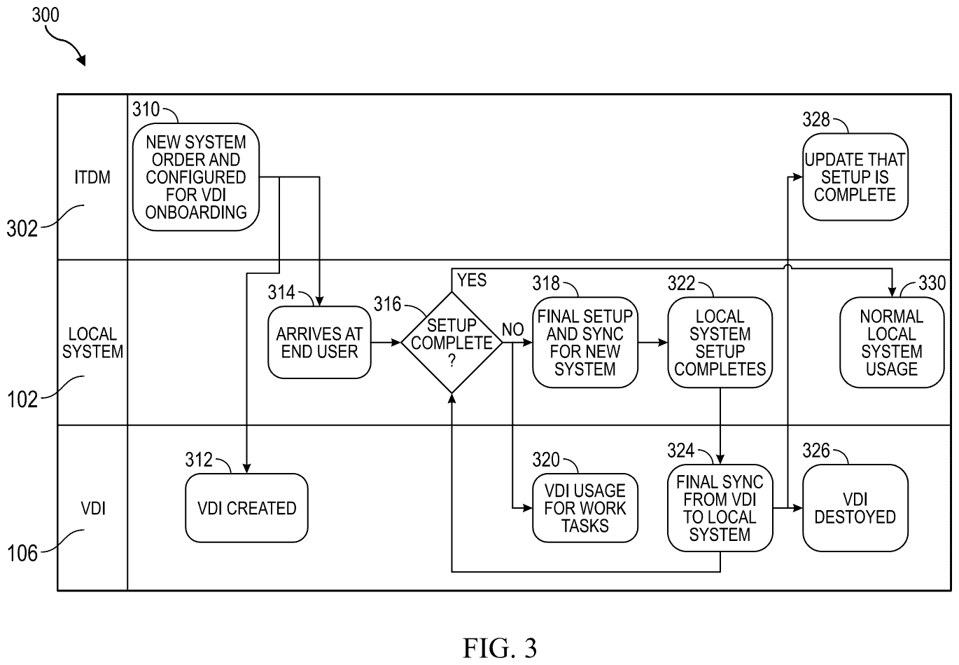

FIG. 3 illustrates an example IHS productivity optimization method 300 that may be used to optimize an IHS 104 during its early lifecycle according to one embodiment of the present disclosure. That is, the IHS productivity optimization method 300 may be used to provide a temporary VDI instance 106 that can be used while a new IHS 104 is being configured for use by an end user. In general, steps 310 and 328 describe actions that may be taken by an ITDM 302 (e.g., administrator) who manages the IHS 104 to be deployed for the end user, steps 314-318, 322, and 330 describe actions that may be taken by the VDI environment management tool 102, while steps 312, 320, 324, and 326 describe actions that may be taken by the VDI instance 106 that is temporarily deployed for use by the end user.

Initially at step 310, the ITDM 302 receives a request to provide a new IHS 104 for the end user, and as a result, a VDI instance 106 is created for use at step 312. If the new IHS 104 is to replace an existing previous IHS, the user environment settings 118, user productivity applications 116, and application settings 120 may be migrated to the VDI instance 106 by the VDI environment management tool 102. For example, the VDI environment management tool 102 running on the previous IHS may obtain the user environment settings 118, user productivity applications 116, and application settings 120 from the previous IHS and communicate with the VDI instance 106 to configure it so that the end user experiences a seamless transition.

After the end user logs into their corporate system, the VDI environment management tool 102 swaps the login session over to a VDI environment 106 that matches their corporate executable image. This VDI instance 106 will have access to all the tools and capabilities the local system would normally have. The VDI environment 106 should possess relatively good performance because it has access to backend scalable resources as needed. In one embodiment, user productivity applications 116 (e.g., email, web browser, word processor, etc.) may be made available via WebView instantly. Additionally, the web browser may be synchronized according to the end user's login, the files from any cloud services may be mapped, and/or any user productivity applications 116 may be provisioned.

At step 314, the new IHS 104 is provided to the end user, and at step 316, the VDI environment management tool 102 determines whether the setup of the new IHS 104 has been completed. If so, processing continues at step 330 in which normal use of the new IHS 104 commences; otherwise, processing continues at step 318 in which the user environment settings 118, user productivity applications 116, and application settings 120 are provisioned on the new IHS 104. During this time, the VDI instance 106 may be used by the end user to perform tasks as would otherwise be performed locally on the new IHS 104 at step 320. In one embodiment, the new IHS 104 may execute a thin client, such as a WebView client, to provide usage of the VDI instance 106 on the new IHS 104.

At step 322, the VDI environment management tool 102 completes local setup of the new IHS 104, and at step 324, the VDI instance 106 performs a final synchronization to migrate any changes made to the VDI instance 106 over to the new IHS 104. Processing then continues at step 316 to ensure that the setup of the new IHS 104 has been completed. If so, processing continues at step 326 in which the VDI instance 106 is destroyed, and at step 328 in which the ITDM 302 reports that setup is completed. Finally at step 330, the VDI environment management tool 102 reverts to providing local system usage for the new IHS 104 for the end user.

The aforedescribed method 300 may be performed each time a new IHS 104 is to be provided for an end user. Nevertheless, when use of the method 300 is no longer needed or desired, the process ends.

Although FIG. 3 describes an example method 300 that may be performed to optimize an IHS 104 during its early lifecycle, the features of the method 300 may be embodied in other specific forms without deviating from the spirit and scope of the present disclosure. For example, the method 300 may perform additional, fewer, or different operations than those described in the present example. For another example, the method 300 may be performed in a sequence of steps different from that described above. As yet another example, certain steps of the method 300 may be performed by other components in the IHS 104 than those described above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” when used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a processor; and
a memory coupled to the processor, the memory having program instructions stored thereon that, upon execution, cause the IHS to, when the IHS is initially provided to an end user:
create a temporary workspace for the end user;
as the IHS is being configured for use by the end user, provide the workspace for use by the user on the IHS; and
when the configuration of the IHS is completed, begin providing the IHS for use by the user.

2. The IHS of claim 1, wherein the workspace is executed external to the IHS.

3. The IHS of claim 2, wherein the workspace comprises a cloud-based VDI environment.

4. The IHS of claim 1, wherein the program instructions, upon execution, further cause the IHS to configure one or more applications on the IHS.

5. The IHS of claim 4, wherein the program instructions, upon execution, further cause the IHS to configure one or more settings for the applications on the IHS.

6. The IHS of claim 1, wherein the program instructions, upon execution, further cause the IHS to configure one or more user environment settings on the IHS.

7. The IHS of claim 1, wherein the program instructions, upon execution, further cause the IHS to provide the workspace to the end user via a thin client executed on the IHS.

8. The IHS of claim 7, wherein the thin client comprises a WebView client.

9. The IHS of claim 1, wherein the program instructions, upon execution, further cause the IHS to, when the IHS is to replace an existing IHS, copy one or more settings on the existing IHS to the workspace.

10. An Information Handling System (IHS) productivity optimization method comprising:
when an IHS is initially provided to an end user:
creating a temporary workspace for the end user;
as the IHS is being configured for use by the end user, providing the workspace for use by the user on the IHS; and
when the configuration of the IHS is completed, begin providing the IHS for use by the user.

11. The IHS productivity optimization method of claim 10, further comprising executing the workspace external to the IHS in a cloud-based VDI environment.

12. The IHS productivity optimization method of claim 10, further comprising configuring one or more applications on the IHS.

13. The IHS productivity optimization method of claim 12, further comprising configuring one or more settings for the applications on the IHS.

14. The IHS productivity optimization method of claim 10, further comprising configuring one or more user environment settings on the IHS.

15. The IHS productivity optimization method of claim 10, further comprising providing the workspace to the end user via a thin client executed on the IHS.

16. The IHS productivity optimization method of claim 10, further comprising, when the IHS is to replace an existing IHS, copying one or more settings on the existing IHS to the workspace.

17. An Information Handling System (IHS) productivity optimization system comprising:
a cloud-based workspace infrastructure configured to create a plurality of workspaces; and
a processor and a memory coupled to the processor, the memory having program instructions stored thereon that, upon execution, cause the IHS productivity optimization system to, when the IHS is initially provided to an end user:
create a temporary workspace for the end user;
as the IHS is being configured for use by the end user, provide the workspace for use by the user on the IHS; and
when the configuration of the IHS is completed, begin providing the IHS for use by the user.

18. The IHS productivity optimization system of claim 17, wherein the program instructions, upon execution, further cause the IHS to configure one or more applications on the IHS.

19. The IHS productivity optimization system of claim 18, wherein the program instructions, upon execution, further cause the IHS to configure one or more settings for the applications on the IHS.

20. The IHS productivity optimization system of claim 17, wherein the program instructions, upon execution, further cause the IHS to provide the workspace to the end user via a thin client executed on the IHS.
